(19) United States
(12) Patent Application Publication
(10) Pub. No.: US 2006/0023850 A1
(43) Pub. Date: Feb. 2, 2006

(54) Power line carrier modem

(76) Inventors: Steven Feldman, New York, NY (US); Gaetano Bonasia, Bronx, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/134,766

(22) Filed: May 20, 2005

Related U.S. Application Data
(60) Provisional application No. 60/574,333, filed on May 25, 2004.

(51) Int. Cl. H04M 11/00

(52) U.S. Cl. 379/90.01

(57) ABSTRACT

A low cost communications device such as a modem reduces electrical interference or noise of signals received from a power line and transmitted to electrical devices. The modem forwards messages and commands between electrical devices and an external computer device. That is, the modem communicates over a power line without the use of a controller such as a microprocessor or microcomputer. The modem can reduce electrical interference of signals received from a power line through the use of an adjustable automatic gain (AGC) circuit.

This application claims the benefit of the filing date of a provisional application having Ser. No. 60/574,333, which was filed on May 25, 2004.

### BACKGROUND OF THE DISCLOSURE

Power line carrier systems may employ an X-10 protocol to allow for the control of X-10 modules over existing house wiring carrying an alternating current (AC) 60 Hz 120 Volts AC (VAC) power signal. An X-10 module includes an electrical device or appliance such as wall switch, lamp, or other electrical device that has an X-10 interface protocol for communicating over the power line. Power line carrier systems use the existing power line of a home as a transmission media which is also used to carry power to other electronic equipment, such as a TV, VCR or audio equipment. However, such equipment often generates electrical interference or noise which may prevent X-10 modules from operating properly.

A controller/transmitter module can be plugged into a standard electrical outlet, or may be installed as a replacement to an existing switch. Each X-10 compatible receiver module is plugged into a standard electrical outlet. The X-10 controller/transmitter can use the electrical wiring as a transmission media to communicate with the X-10 receiver modules. Thus, the X-10 controller/transmitter can communicate with an X-10 module, which, in turn, can control an electrical device or appliance.

To control specific modules, all modules are assigned an address, which can consist of a House and Unit code. The transmitter module can send a command signal over the power line directed to a receiver module identified by a specific House and Unit code. Although various receiver modules may be connected to the power line, only the receiver module having the specific House and Unit code in the command signal responds to the command. A command signal can include instructions requesting that a module controlling an electrical device, such as a “lamp,” to turn on or off. A transmitter also can send a command signal requesting the status of the receiver module. In response, the receiver module can check the module status and send a message signal indicating the status.

An X-10 transmitter/receiver module can employ amplitude modulation (AM) to transmit binary data over the household electrical wiring. In order to differentiate the data, the carrier uses the zero-crossing point of the 60 Hz AC wave. Synchronized receivers accept the carrier at each zero-crossing point. X-10 uses two zero-crossings to transmit the binary data to reduce errors in communication between the transmitter and the module receiver.

The transmitter and module receiver may communicate by using binary 1's and 0's when the AC wave crosses the zero voltage level. A binary 1 may be represented by a 1 millisecond burst of 120 kilohertz (KHz) at the zero-crossing point and a binary 0 by the absence of a 120 KHz burst. These 1 millisecond bursts can be transmitted three times to coincide with the zero-crossing points of all three phases in a three phase distribution system. A complete code transmission can encompass eleven cycles of the power line. The first two cycles can represent a Start Code. The next four cycles represent a House Code and the last five cycles represent a Unit Code (1 thru 16) or a Function Code (On, Off, etc.). This complete block, (Start Code, House Code, Unit or Function Code) can be transmitted in groups of 2 with 3 power line cycles between each group of 2 codes.

A power line carrier X-10 transmitter/receiver module can include an interface modem for interfacing to the power line and a controller such as a microcontroller or microprocessor to extract, process and interpret X-10 command and message signals from the power line. The modem may increase the cost and the complexity of the module.

### SUMMARY OF THE DISCLOSURE

There is disclosed a low cost communications device (i.e., modem) that reduces electrical interference on received command and message signals. The modem forwards messages and commands between electrical devices and an external computer device. The generation of commands and the processing and interpretation of messages are performed by the external computer device and not by the modem. That is, the modem communicates over a power line without the use of a controller such as a microprocessor or microcomputer. The modem can reduce electrical interference of signals received from a power line through the use of an adjustable automatic gain (AGC) circuit.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest terms.

### BRIEF DESCRIPTION OF THE DRAWINGS

Other aspects, features, and advantages of the present disclosure will become more fully apparent from the following detailed description, the appended claim, and the accompanying drawings in which similar elements are given similar reference numerals.

FIG. 1 is a schematic diagram of a control circuit of a power line modem;

FIG. 2 is a schematic diagram of an automatic gain circuit of the power line modem;

FIG. 3 is a schematic diagram of an opto-isolation circuit of the power line modem;

FIG. 4 is a diagram of a power line signal used by the power line modem;

FIG. 5 is a timing diagram of the reception of message signals in the power line modem;

FIG. 6 is a timing diagram of the transmission of command signals from the power line modem;

FIG. 7 is a diagram of a housing for the power line modem;

FIG. 8 is a diagram of a data communications connector used in a power line modem;

FIG. 9 is a diagram of another data communications connector used in a power line modem;

FIG. 10A-10B illustrate an implementation of a format for a power line transmitted code; and

FIG. 11 is an example of house and key codes.

### DETAILED DESCRIPTION

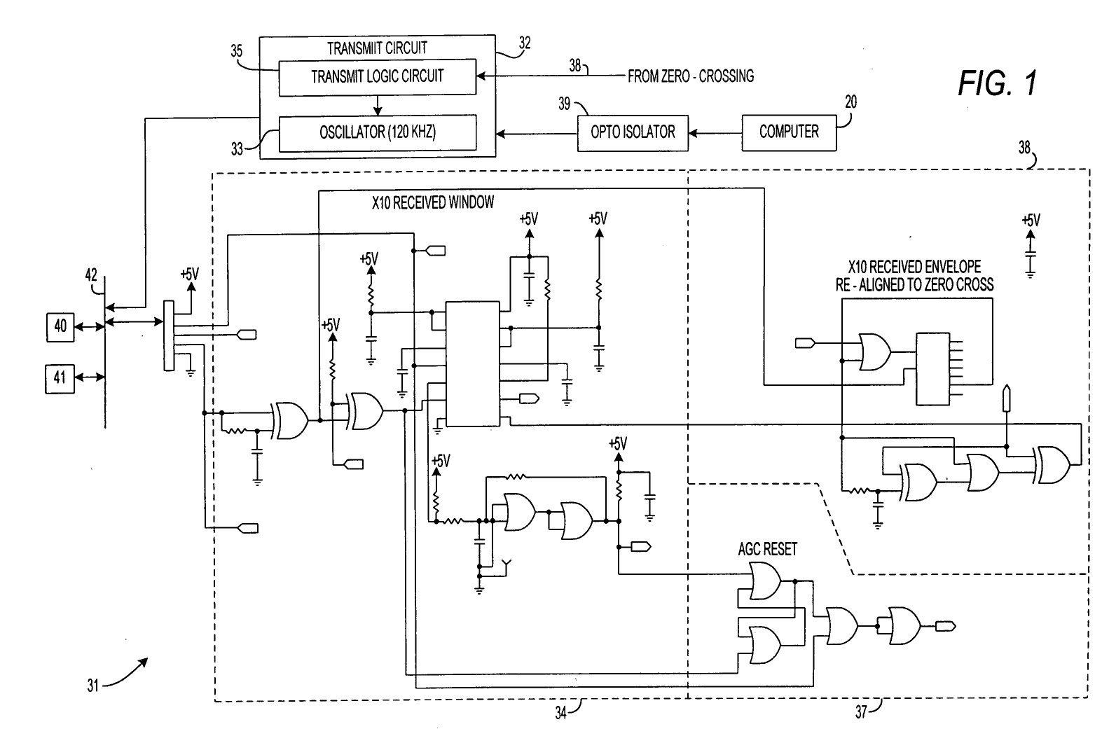

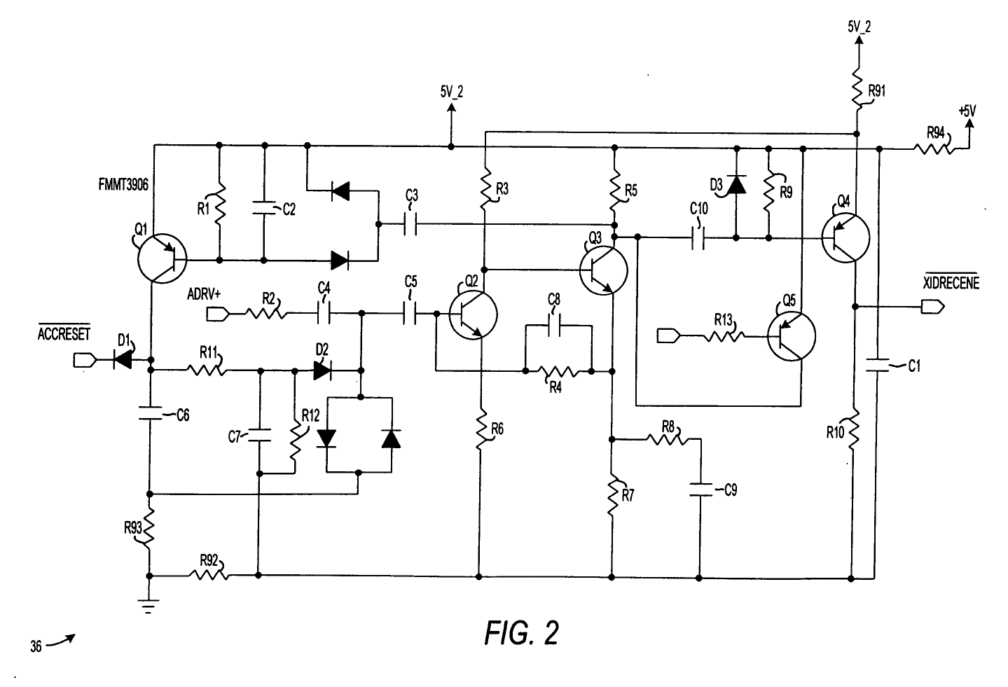

Referring to FIG. 1, the modem can forward messages and commands between electrical devices 40, 41 and a computer device 20. The generation of commands and the processing and interpretation of messages is performed by computer device 20, not by modem 30. That is, modem 30 communicates over a power line without the use of a controller such as a microprocessor. In addition, the noise immunity of modem can be increased through the use of an automatic gain control circuit (AGC) 36 (FIG. 2). The present techniques disclose a modem having a low cost, high performance power line interface exhibiting high noise immunity.

In one embodiment, power line modem includes a control circuit 31 for controlling a transmit circuit 32 and a receive circuit 34. The transmit circuit 32 receives commands from computer device 20 over a data communications line 22 and forwards the commands to electrical devices 40, 41 over power line 42. The data communications line 22 may include a digital or analog line for handling data communications, such as the Internet, using wired or wireless communications channels or the like. The power line 42 includes standard residential house wiring carrying a 60 Hz 120 VAC. The computer device 20 refers to a device having a controller with data processing capability including a personal digital assistant, a cellular phone and a personal computer. The computer device 20 can include standard components such as a screen, keyboard, memory, communications interface and other components. A command signal is an X-10 compatible signal that includes a House Code and a Unit/key Code to uniquely identify electrical devices 40, 41 and information for controlling the electrical devices. An example of a command signal includes a code instructing a device, such as a lamp, to turn on or off. A command signal also can include a code requesting the status of an electrical device on the power line. An electrical device is defined as an X-10 module having a power line interface that can be controlled by commands from another device over the power line and/or can transmit messages related to the status of the device. An example of an electrical device includes an electrical receptacle, an electrical switch, a lamp, an electrical appliance.

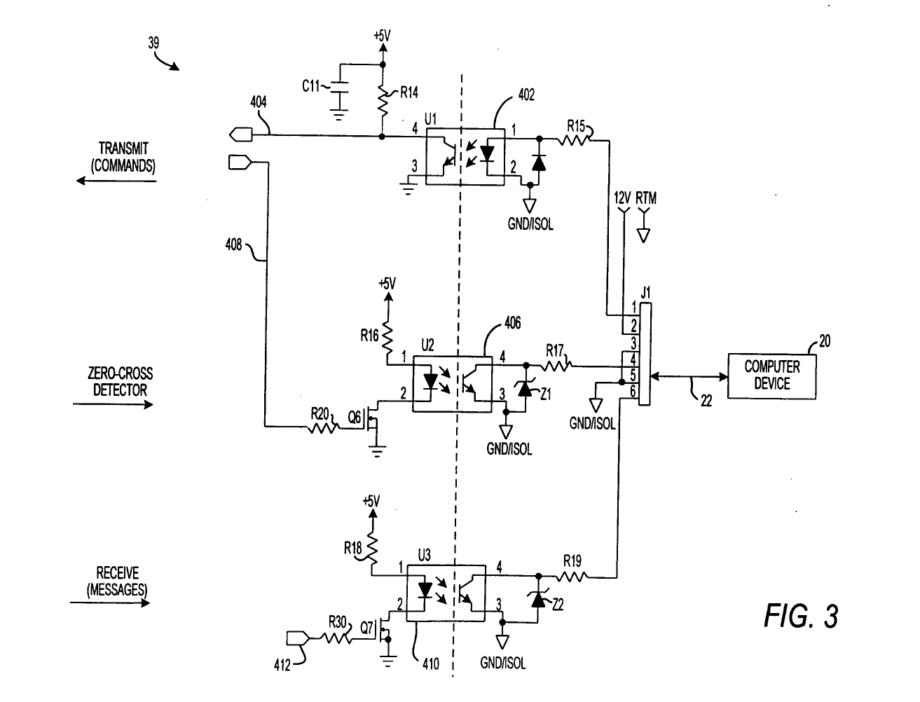

The receive circuit 34 can receive message signals from electrical devices 40, 41 and forward the messages to computer device 20 for subsequent processing. Message signals are X-10 compatible signals that include information and/or data related to the status of electrical devices 40, 41. An automatic gain control (AGC) circuit 36 provides automatic gain functionality to the receive circuit, to help increase the noise immunity of the receive circuit. Zero-crossing circuit 38 facilitates the synchronization of the receive circuit and/or the transmit circuit to the zero-crossing point of the power line so that the modem can synchronize its operation. An opto-isolation circuit 39 (FIG. 3) can provide electrical isolation between computer device 20 and electrical device 40, 41. The modem also facilitates connection to a control bus interface (CBI) which is an embedded web server for controlling Decora home control (DHC) devices over the Internet. The DHC products are produced by Leviton Manufacturing Co., Inc., the assignee of this invention.

The transmit circuit 32 includes transmit logic circuit 35 for receiving command signals from the computer device 20 through data communication line 22 and forwarding (modulating) the command signals onto the power line 42. The signals from the computer device 20 include digital pulses ranging between a low level (e.g., nominally at zero volts) and a high level (e.g., nominally 5 volts) for approximately 1 millisecond after or at the zero-crossing point of the wave on the power line. The signals may be within 100 microseconds of the zero-crossing point. Transmit circuit 35 triggers a 120 KHz Oscillator circuit 33 that generates a 1 millisecond burst for modulating the signal on the AC power line 42.

Receive circuit 34 receives message signals from electrical devices 40, 41 over AC power line 42 and realigns the signal to the zero-crossing point of the power line signal. The realigned signal then can be provided to the opto-isolation circuit 39 (See FIG. 3). Realignment can occur during a zero-crossing window defined as a period of time between zero-crossing points of the power line signal.

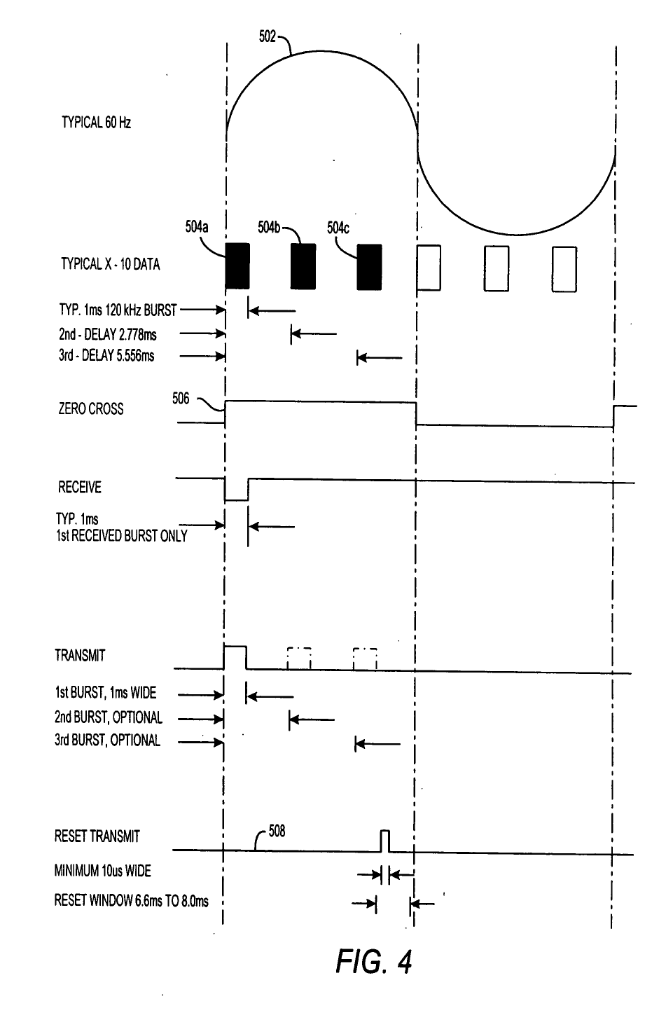

Zero-crossing circuit 38 can monitor the AC power line 42 and generates a zero-crossing signal that can be provided to the data communication line through opto-isolation circuit 39 (See FIGS. 1 and 4). The zero-crossing signal can be used by the computer device 20 to synchronize the exchange of signals with modem 30. Control circuit 31 can use each edge of the zero-crossing signal to generate a 1 millisecond pulse delayed by 100 microseconds from the zero-crossing point for use by AGC circuit 38 (See FIGS. 1 and 3).

AGC Reset circuit 37 can receive a unique command signal from the computer device 20 and, based on the signal, generate a reset signal for resetting AGC circuit 36 (FIGS. 2).

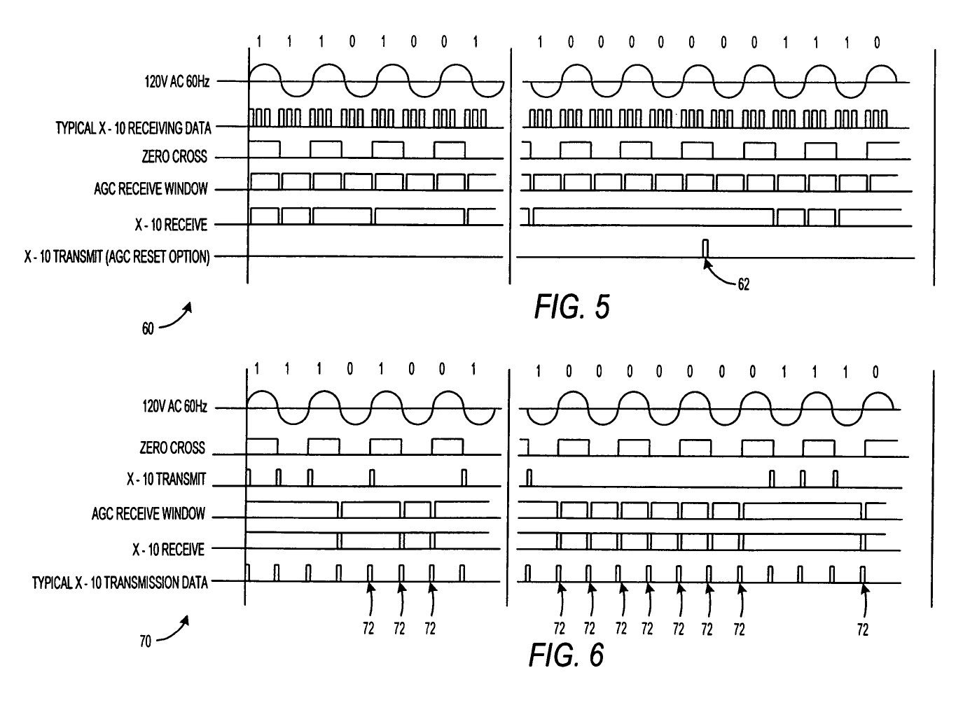

FIG. 2 is a schematic diagram of an implementation of an AGC circuit 36 of a power line modem. Upon the completion of a command signal from the computer device 20, the computer device sends a unique command to the AGC circuit to reset the AGC. This is described in detail below in reference to FIG. 5 and the description thereof.

In one embodiment, AGC circuit 36 is a gated-type AGC because it only operates during a signal window (i.e., between zero-crossing points of the AC power line signal) when the receive circuit checks for message signals from the power line. Noise levels during the signal window may not be as strong as during the other portions of the AC power curve. This technique desensitizes the receive circuit to noise signals with only a minimal reduction in message signal sensitivity. As a result, noise interference may be reduced without affecting overall system performance. In another embodiment, a non-gated AGC can be used in the present invention. In a non-gated AGC, the receive circuit can be desensitized to high noise levels throughout the entire AC power cycle instead of just during the signal window as in a gated type of AGC.

FIG. 3 is a schematic diagram of an implementation of an opto-isolation circuit 39 of a power line modem. A first opto-isolator 402 receives a command signal from computer device 20 through data communication line 22. The first opto-isolator generates an isolated command signal, over a Transmit wire 404, which is then forwarded to control circuit 31 (FIG. 1). A second opto-isolator 406 receives a digital zero-cross signal, over a zero-cross wire 408, from the control circuit (not shown) and generates an isolated output zero-crossing signal which is fed to computer device 20 through data communication line 22. In a similar manner, a third opto-isolator 410 receives, over a receive wire 412, a message signal from an electrical device through the control circuit (not shown) and generates an isolated output message to the computer device. A low level bit having a duration of approximately 600 microseconds may be sufficient for the computer device to determine that the bit is valid. The output of the third opto-isolator may be pulled up to a high level (e.g., nominally 5 volts) and then pulled down to a low level (e.g., nominally 0 volts) for approximately 8.3 milliseconds at the zero-crossing point of the 60 Hz signal on the power line.

FIG. 4 is a timing diagram of a power line signal used by a power line modem according to an embodiment of the invention. The diagram shows the timing relationships of transmission bursts during three phases of a three phase power distribution system. In one embodiment, a power line signal in a power distribution system is a standard 60 Hz 120 VAC power line signal 502 that may be used in a residence. The transmit circuit of the modem modulates the 60 Hz signal with three bursts of 120 KHz 504a, 504b, 504c. A binary 1 can be represented by a 1 millisecond burst of 120 KHz and a binary 0 can be represented by an absence of a 1 millisecond burst of 120 KHz. The three bursts can be equally spaced to coincide with the zero crossing point of each phase in a three-phase system. During the first phase of a three phase cycle, immediately after the zero-crossing 506 of the AC cycle, a first 1 millisecond burst of 120 KHz 504a may be generated by the transmit circuit of the modem. Next, during the second phase of the cycle, approximately 2.778 milliseconds after the zero crossing point of the curve, a second 1 millisecond burst of 120 KHz 504b can be generated by the transmit circuit of the modem. During the third phase of the cycle, approximately 5.556 milliseconds after the zero-crossing point of the curve, a third 1 millisecond burst of 120 KHz 504c can be generated by the transmit circuit of the modem. At approximately 6.6 to 8 milliseconds from the zero-crossing point 508, no transmission takes place. Rather, the modem can check for the occurrence of a collision, which is described in detail with reference to FIG. 6 and the description thereof.

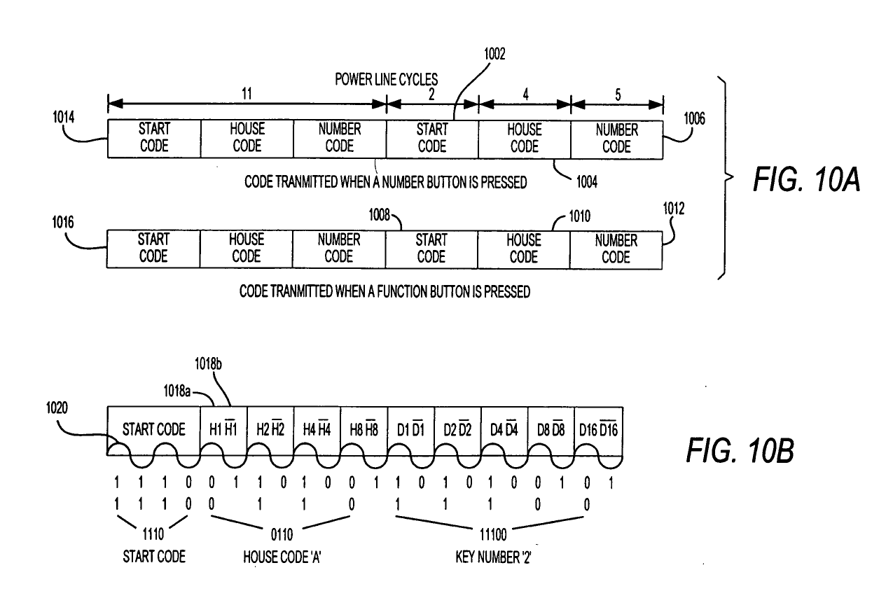

FIGS. 10A-10B illustrate an implementation of a data block that may be transmitted over the power lines to an X-10 receiver module. As discussed above, a binary 1 may be represented by a 1 millisecond burst of 120 kHz at a zero crossing point, and a binary 0 by the absence of a 120 kHz burst at a zero crossing point. FIG. 10A illustrates two code transmission blocks. A first block is a number code transmission block 1014 and a second block is a function code transmission block 1016. A complete code transmission block of either type can take eleven cycles of the power line. In an implementation, the first two cycles may be used for the Start Code 1002, 1008. The subsequent four cycles can identify a House Code 1004, 1010 associated with a particular house and the last five cycles represent a key code, which may either be the Number Code 1006 (1 thru 16) or a Function Code 1012 (On, Off, etc.). To affect a particular X-10 receiver, two code sequences may be transmitted. An operator can press a first button to transmit the first code sequence 1014 to identify a particular X-10 receiver by house number 1002 and number code 1004 associated with a particular receiver in the identified house. Similarly, the operator may press a second button to send a function code 1012 associated with a desired function to be performed. This complete block, (Start Code, House Code, Key Code) may be transmitted in groups of 2 with 3 power line cycles between each group of 2 codes. Referring to FIG. 10B, within each block of data, each four or five bit code may be transmitted in true complement form (e.g., 1018a and 1018b) on alternate half cycles of the power line 1020. That is, if a 1 millisecond burst of signal is transmitted on one half cycle (binary 1) then no signal would be transmitted on the next half cycle (binary 0). The Start Code is a defined sequence and is illustrated, in this example, as 1110, which is a unique code and is the only code which does not follow the true complementary relationship on alternate half cycles

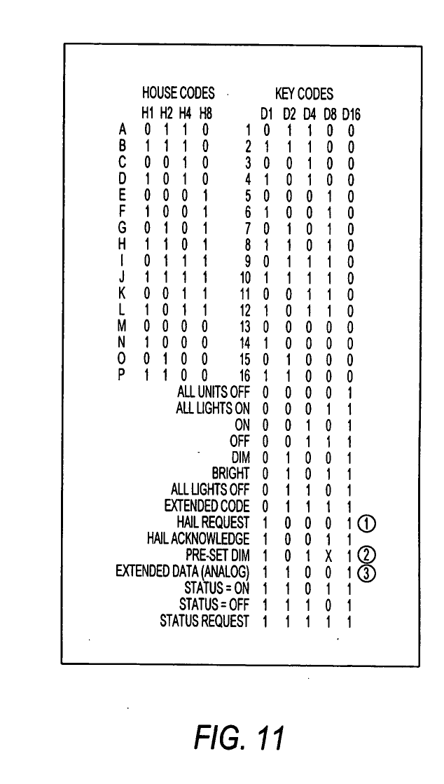

FIG. 11 is a sample table of codes that may be transmitted for each House Code and Key Code. In the implementation shown, sixteen houses A-P may be addressed, In this example, sixteen number codes 1-16 have been defined and fifteen function codes identify operations for the X-10 receivers to perform.

FIG. 5 is a timing diagram of the reception of messages in a power line modem according to an embodiment of the invention. As described below in detail, the present invention generates a narrow digital pulse signal, represented by arrow 62, for resetting the AGC circuit. First, a description of the signals is presented. A 120 VAC 60 Hz signal represents the signal over the AC power line (hereinafter AC power signal). A Typical X-10 Receiving Data signal represents a message signal in a digital binary format demodulated from the AC power signal, before it is forwarded to the computer device over the data communications line. A Zero-Cross signal is a digital pulse that coincides with the zero-crossing of the AC power signal. It is used by the power line system including the modem and the computer device to synchronize the transmission of commands and messages over the power line.

An AGC Receive window signal is a digital pulse that coincides with the zero-crossing of the AC power signal and is used by the modem to sample received message signals from the AC power line. An X-10 Receive signal represents a message signal in a digital binary format that is forwarded from the modem to the computer device via the data communications line. Similarly, an X-10 Transmit signal represents a command signal in a digital binary format that is sent by the computer device to the modem and forwarded to the power line by the modem.

The top of the diagram shows a Start Code that encompasses the first two full cycles of the AC power signal. As described above, a binary 1 may be represented by a 1 millisecond burst of 120 KHz whereas a binary 0 may be represented by an absence of a 1 millisecond burst. The Start Code can be represented by a binary code having a value of “1 1 1 0.” So, for the first digit “1” of the code, three bursts are generated during the first half cycle, for the second digit “1” of the code, three bursts are generated during the second half cycle and for the third digit “1” of the code, three bursts are generated during the next half cycle. However, for the fourth digit “0” of the code, no burst is generated because a digit “0” is transmitted by an absence of a burst (shown as three “light” pulses).

After the transmission of the Start Code, the next code is a Logic 1 which results in the generation of three consecutive 1 millisecond bursts during the first half cycle. The protocol may have the generation of the complement of the previous value. Hence, for the Logic 1 code, a value of 0 is generated during the second half cycle resulting in the absence of burst during this half cycle. Similarly, the generation of a Logic 0 code results in the absence of bursts during the first half cycle and, for the complement, the generation of bursts during the second half of the cycle.

Once the block of data having the Start Code and the other codes are generated, a termination code marking the end of the block, referred to as an End of Message code, may be generated. This code may include six AC cycles having the value of zero. This is transmitted as six half cycles of an absence of a burst (shown as “light” pulses).

In the implementation illustrated, during the fourth or the sixth cycle, the modem can receive from the computer device a unique reset command (arrow 62) for resetting the AGC circuit. The reset signal may be generated approximately between 6.6 milliseconds 8 milliseconds after the zero crossing point. The reset signal may be a narrow digital pulse signal (e.g., pulse duration of approximately 10 microseconds) compared to a typical 1 millisecond burst. This reset command signal can shares the same serial transmit connection used for command signals transmitted over the power line. The reset command signal may be timed to occur at a time other than during the zero-crossing point. Such a feature can help reduce interference with standard X-10 communications.

FIG. 6 is a timing diagram 70 of the transmission of commands from a power line modem according to an embodiment of the disclosure. The present disclosed techniques can monitor or check for the occurrence of collisions during the transmission of data over the power line as shown by arrows 72. The X-10 Transmit signal can show the transmission of data coincident with the Zero-Cross signal. The modem checks (arrows 72) for the occurrence of a collision during the absence of a burst and coincident with the low level value of the AGC Receive window signal.

Many of the signals shown in this diagram are similar to the signals shown in FIG. 5. For example, the 120 VAC 60 Hz (i.e., the AC power signal), the Zero-Cross signal, the AGC Receive window signal, the X-10 Receive signal and the X-10 Transmit signal are the same as the similarly named signals in FIG. 5. However, since FIG. 6 deals with the transmission of data, a Typical Transmit Data signal is used instead of the Typical X-10 Receiving Data signal of FIG. 5. The Typical Transmit Data signal represents a command signal in a digital binary format that is received from the computer device and is forwarded by the modem over the AC power line.

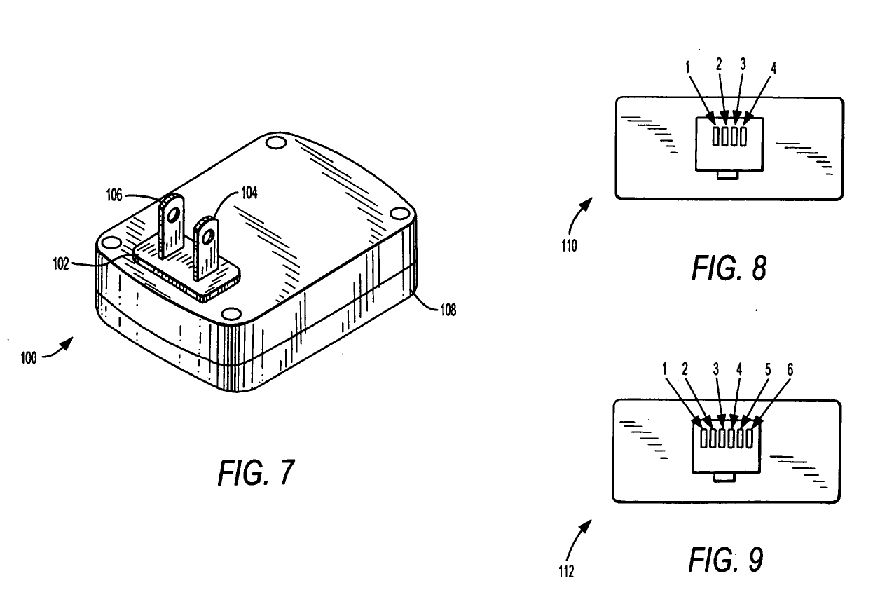

FIG. 7 is a diagram of a housing 100 for accommodating a power line modem according to an embodiment of the disclosure. The housing 100 includes a standard two-prong electrical wiring plug 102 for providing a physical and electrical connection to a standard electrical outlet (not shown). The plug 102 includes a phase prong 104 and a neutral prong 106 which are used to provide electrical power to the modem as well as to carry X-10 commands and messages between the power line and the modem. A data communications connector 108 (not shown) on the bottom of the housing provides a physical connection between the modem and the computer device.

FIG. 8 is a diagram of a data communications connector 110 used in a power line modem according to an embodiment of the invention. The connector 110 is a standard 4-pin telephone jack for providing an electrical and physical connection between the modem and the computer device. Pin 1 is an output conductor for carrying a zero-crossing signal from the modem to the computer device to allow the computer device to synchronize its operation according to the zero-crossing point of the AC power line. Pin 2 is a Ground conductor for providing an electrical reference point between the computer device and the modem. Pin 3 is an output conductor for carrying X-10 Receive signals representing messages in a digital format from the modem. Pin 4 is an input conductor for carrying X-10 Transmit signals representing commands from the computer device to the modem for transmission over the power line.

FIG. 9 is a diagram of a data communications connector 112 used in a power line modem according to an embodiment of the invention. The connector 112 is a standard 6-pin telephone jack for providing an electrical and physical connection between the modem and the computer device. The connector 112 is a 6-pin jack similar to the 4-pin jack of FIG. 8 except for the pin designations. Pins 1 and 3 are Ground conductors for providing an electrical reference point between the computer device and the modem. Pin 2 is an output conductor for carrying a zero-crossing signal from the modem, like pin 1 of connector 110 of FIG. 8. Pin 4 is an input conductor for transmitting X-10 Receive signals from the modem, like pin 3 of connector 110 of FIG. 8. Pin 5 is an input conductor for receiving X-10 Transmit signals from the computer device, like pin 4 of connector 110 of FIG. 8. Pin 6 normally would normally carry a 12 VDC power signal, but is not used in this application.

The foregoing has outlined, rather broadly, a preferred blending feature, for example, of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

1. A method of controlling an electrical device comprising:
receiving a command code from an external data communications line by a receiver;
modulating a power line wave with the command code;
receiving a response code from an external electrical device in communication with the power line wave; and
transmitting the response code to the external data communications line.

2. The method of claim 1, further comprising determining a zero crossing of the power line wave and wherein modulating the power line wave comprises a frequency burst at a zero crossing of the power line wave.

3. The method of claim 2, wherein the frequency burst is 120 kilohertz for 1 millisecond.

4. The method of claim 1, comprising automatically adjusting the gain of the modulation to increase noise immunity.

5. A power line modem having a control circuit comprising:
a transmit circuit to receive a command code from an external data communications line and to modulate a power line wave in response to the command code;
a receive circuit to receive a response code on the power line wave and provide the response code to the external data communication line; and
a zero-crossing circuit to synchronize the receive circuit and/or the transmit circuit to the zero-crossing point of the power line,
wherein the command codes include indicia of a selected external electrical device and a desired action, and
wherein the response codes include indicia of a status of the responding electrical device.

6. The power line modem of claim 5, further comprising an automatic gain control circuit, electrically coupled to the control circuit, to increase the noise immunity of the receive circuit.

7. The power line modem of claim 6, wherein the automatic gain control circuit is controlled by commands received from the data communications line.

8. The power line modem of claim 5, comprising an opto-isolation circuit to provide electrical isolation between the power line modem and the data communications line.

9. The power line modem of claim 5, comprising an electrical wiring plug for interfacing to the power line.

10. The power line modem of claim 5, comprising a telephone jack for interfacing to the data communications line.

11. The power line modem of claim 5, wherein the data communications line is a wired or wireless communications line.

12. The power line modem of claim 1 wherein the power line wave is a standard alternating current (AC) 60 Hertz 120 Volts alternating current (VAC) power line used in a residential setting.

13. The power line modem of claim 1, wherein the commands and the response codes are X-10 protocol compatible.

14. A system for controlling an electrical device from a remote location, comprising
a computer device to provide a command code and receive a response code;
a wired or wireless data communications line to couple the computer device to the power line modem;
a power line modem including:
a transmit circuit to receive the command code from the data communications line and to modulate a power line wave in response to the received command code;
a receive circuit to receive a response code on the power line wave and provide the response code to the data communication line;
a zero-crossing circuit to synchronize the receive circuit and/or the transmit circuit to the zero-crossing point of the power line wave; and
an electrical device coupled to the power line wave,
wherein the data communication line, the electrical device and the computer device are external to the power line modem.

15. The system of claim 14, wherein the command code includes indicia of a selected external electrical device and a desired action, and wherein the response code includes indicia of a status of a responding electrical device.

16. The system of claim 14, wherein the computer device comprises a controller having a microprocessor or microcontroller with data processing capability and includes at least one of a personal digital assistant, a cellular phone or a personal computer.

17. The system of claim 14, wherein the electrical device is a device having a power line wave interface for communicating over the power line wave and includes at least one of an electrical receptacle, an electrical switch, a lamp or an electrical appliance.

18. The system of claim 17, wherein the electrical device is compatible with X-10 protocol.

19. The system of claim 14, wherein the computer device receives pulse signals for improved collision and reply detection.

20. The system of claim 14, wherein the computer device transmits over the data communication line a pulse signal to reset an automatic gain circuit (AGC) of the power line modem to improve reception of data from the power line wave.
